(19) United States
(12) Patent Application Publication
(10) Pub. No.: US 2015/0338668 A1
(43) Pub. Date: Nov. 26, 2015

(54) Naked Eye 3D Polarized Structure and Manufacturing Method Thereof

(71) Applicant: EverDisplay Optronics (Shanghai) Limited, Shanghai (CN)

(72) Inventors: Yanpin Gao, Shanghai (CN); Baocai Zhai, Shanghai (CN)

(73) Assignee: EverDisplay Optronics (Shanghai) Limited

(21) Appl. No.: 14/462,743

(22) Filed: Aug. 19, 2014

(30) Foreign Application Priority Data
May 26, 2014 (CN) 201410225415.9

(51) Int. Cl. G02B 27/22; G02B 27/26

(52) U.S. Cl. CPC G02B 27/2214; G02B 27/26; B33Y 10/00

(57) ABSTRACT

In a naked eye 3D polarized structure and a manufacturing method of the naked eye 3D polarized structure, the naked eye 3D polarized structure includes a polarizer, a 3D grating layer disposed in the polarizer and having a PET film, and a lens structure installed in the PET film and containing nitrogen or being vacuumed. The lens structure installed on the 3D grating layer in the PET film is capable of protecting the lens structure from being affected by external forces, so as to prevent external stresses from affecting the mechanical property of the 3D grating layer during the attaching and application processes of the 3D grating layer.

### CROSS REFERENCE TO RELATED APPLICATION

This application claims the benefit of priority to CN 201410225415.9, filed on May 26, 2014 with the State Intellectual Property Office of the People's Republic of China, the entire specification of which is herein incorporated by reference.

### BACKGROUND OF THE INVENTION

1. Fields of the Invention

The present invention relates to the field of a three-dimensional (3D) display technology, and more particularly, to a naked eye 3D polarized structure and a manufacturing method of the naked eye 3D polarized structure.

2. Descriptions of Related Art

While people are observing objects in the real world, both eyes are situated different levels, so that the pupillary distance exists, and the physical images observed by the left and right eyes are different, and the parallax exists between the images. With the existence of the parallax which is processed by our brain and nerves, we can sense the change of stereoscopic depths of the three-dimensional world, and it is the so-called three-dimensional (3D) vision principle.

Basically, the 3D image display device is divided into a glass type 3D image display device and a glassless type (naked eye) 3D image display device. The glass type 3D image display device comes with a pair of glasses, and thus it is relatively inconvenient to viewers, and the naked eye (or glassless) 3D image display device allows the viewers to view 3D images simply and directly from a screen. At present, extensive and profound researches of the glassless type 3D image display device are conducted.

The display method of the glassless type 3D image display device (also known as a naked eye 3D display method includes a lens method and a parallax barrier method. In the parallax barrier method, a parallax barrier installed between a backlight module and an LCD panel and situated in a 3D display mode may block a viewer's right eye by opaque fringes when an image seen by the viewer's left eye should be displayed on an LCD screen, and vice versa, so that the viewer is able to see a 3D image. However, the backlight is blocked by the parallax barrier in the parallax barrier method, the brightness of the display will drop, and it is relatively difficult to see a high-brightness screen. In the lens method, a cylindrical lens technology including a biconvex lens or micro cylindrical lens technology is generally adopted. Compared with the parallax barrier method, the major advantage of the lens method resides on that the brightness is not affected. In the parallax barrier method, a cylindrical lens is added in front of the LCD screen, so that that the image plane of the LCD screen is situated on the focal plane of the lens, and a graphic element of an image under each cylindrical lens is divided into a plurality of sub-pixel elements, and the lens is able to project the sub-pixel elements in different directions. Therefore, the viewer's eyes looking at the display screen from different angles are able to see different sub-pixel elements.

With reference to FIG. 1 for a conventional display structure of a naked eye 3D display screen, the display structure comprises a TFT layer 101, an organic layer 102, a glass layer 103, a POL layer 104, an OCA layer 105, a TP layer 106, and a 3D grating layer 107 disposed sequentially on one another. The 3D grating layer 107 is disposed on the TP layer 106 (touch panel layer), and the TP layer 106 is adhered onto the POL layer 104 (polarizer layer) through the OCA layer 105 as shown in FIG. 2. The 3D grating layer 107 comprises an array cylindrical lens structure 1071 having an obliquely extended array cylindrical lens film covered onto the touch panel to achieve the 3D effect. When the naked eye 3D display screen is manufactured, the lens structure may be damaged easily by an external stress if a convex surface of the cylindrical lens structure 1071 in the 3D grating layer 107 faces towards the outside (or towards the TP layer 106). In the display structure as shown in FIG. 1, the cylindrical lens structure or TP structure may be damaged by the external stress, and the mechanical property of the display equipment is affected adversely.

The present invention intends to provide a naked eye 3D polarized structure and a method of manufacturing the structure to eliminate the shortcomings mentioned above.

### SUMMARY OF THE INVENTION

The primary objective of the present invention to provide a naked eye 3D polarized structure and a manufacturing method of the polarized structure capable of overcoming the problem of the conventional naked eye 3D technology, in which the lens structure or TP structure is damaged by the external stress easily.

To achieve the aforementioned objective, the present invention provides a naked eye 3D polarized structure, comprising: a polarizer, and a 3D grating layer disposed in the polarizer, and the 3D grating layer includes a PET film, and a lens structure disposed in the PET film, and the lens structure includes nitrogen or is vacuumed.

With the aforementioned 3D grating layer, the lens structure is formed in the PET film, and upper and lower surface of the 3D grating are flat, so that the lens structure is protected from being affected by external forces. Since the lens structure is disposed in the PET film, the lens structure gives a protection, and the mechanical property of the display equipment is not affected by the external structure in the process of attaching or using the 3D grating layer. The lens structure is filled with nitrogen or vacuumed, so that there is a refractive index difference value between the interior of the lens structure and the PET film outside the lens structure, and a lens formation condition is established. An image is projected in different directions through the lens structure 302 to achieve the naked eye 3D effect. In addition, the 3D grating layer disposed in the polarizer not just overcomes the issue of damaging the TP structure when the convex surface of the lens structure faces towards the outside only, but also simplifies the manufacturing procedure of the display equipment, so as to achieve the effects of saving the cost, improving the production effectively. The 3D grating layer and the polarizer are combined to eliminate the possibility of having an error when the naked eye 3D display equipment is attached, so as to improve the product quality.

Compared with the prior art, the naked eye 3D polarized structure of the present invention has the following advantages: The lens structures and the pixel structures are corresponsive to one another, and each pixel structure is corresponsive to each respective lens structure, so that the optical path between such lens structures is not affected, and the Moire phenomenon can be reduced or even eliminated.

In the naked eye 3D polarized structure of the present invention, the lens structure is in the shape of a spherical lens or an ellipsoidal lens.

In the naked eye 3D polarized structure of the present invention, the lens structure is greater than the corresponsive pixel structure. The size and shape of the lens vary with the pixel structure to avoid a black gap between the graphic elements is amplified by the lens, and such black gap may cause human eyes seeing a black screen at a specific position, instead of a 3D screen, and thus the present invention ensures the 3D viewing effect.

In the naked eye 3D polarized structure of the present invention, the polarizer includes a polarizing element and a surface treatment layer, and the 3D grating layer is disposed between the polarizing element and the surface treatment layer.

The present invention further provides a manufacturing method of a naked eye 3D polarized structure, and the manufacturing method comprises the steps of: forming a lens structure inside a PET film, wherein the lens structure is filled with nitrogen or vacuumed; and installing the PET film together with the lens structure into the polarizer.

In the manufacturing method of a naked eye 3D polarized structure of the present invention, the lens structures and the pixel structures are corresponsive to one another.

In the manufacturing method of a naked eye 3D polarized structure of the present invention, the lens structure is filled with nitrogen or vacuumed by the following method: A lens structure is formed in a nitrogen environment or a vacuum environment, or nitrogen is filled into the lens structure or the lens structure is vacuumed.

In the manufacturing method of a naked eye 3D polarized structure of the present invention, the lens structure is formed inside the PET film by a 3D printing technology, or the lens structure is formed inside the PET film by a PET embossing method.

In the naked eye 3D polarized structure of the present invention, the lens structure is greater than the corresponsive pixel structure.

In the naked eye 3D polarized structure of the present invention, the polarizer includes a polarizing element and a surface treatment layer, and the 3D grating layer is disposed between the polarizing element and the surface treatment layer.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a schematic view of a conventional naked eye 3D display structure;

FIG. 2 is a schematic view of a 3D grating layer of the structure as depicted in FIG. 1;

FIG. 3 is a schematic view of a naked eye 3D polarized structure of the present invention;

FIG. 4 is a cross-sectional view of a 3D grating layer as depicted in FIG. 3, and

FIG. 5 is a flow chart of a manufacturing method of a naked eye 3D polarized structure in accordance with the present invention.

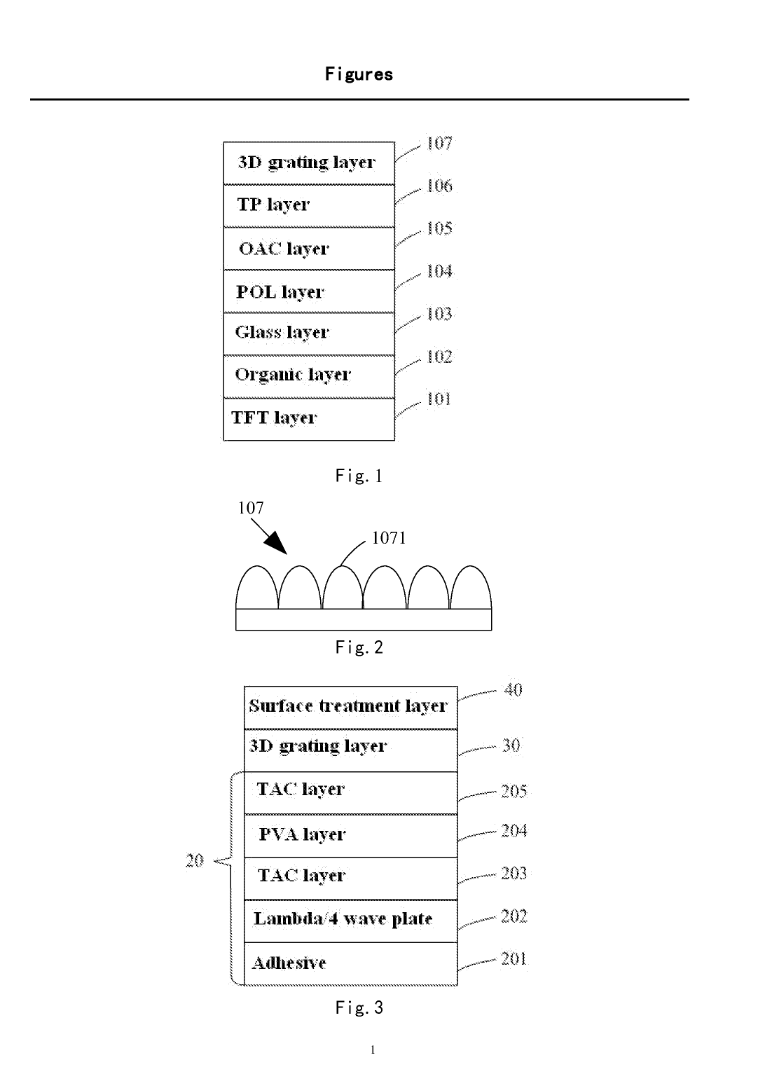

### DETAILED DESCRIPTION OF THE PREFERRED EMBODIMENT

With reference to FIG. 3 for a schematic view of a naked eye 3D polarized structure of the present invention, the present invention comprises a 3D grating layer disposed in a polarizer, so that the 3D grating layer containing a lens structure is combined with the polarizer to achieve a naked eye 3D function. Such arrangement can simplify the manufacturing procedure of the naked eye 3D display equipment to improve the production efficiency. In the 3D grating layer of the present invention, the lens structure is formed in the PET film, so that the PET film can effectively protect the lens structure from being affected by external forces. In addition, the lens structure is filled with nitrogen or vacuumed, so that there is a refractive index difference between the exterior of the lens structure and the interior of the lens structure, and a lens formation condition is established. The naked eye 3D polarized structure of the present invention can effectively overcome the problem of the prior art that the lens structure or the TP structure may be damaged by external stresses easily.

With reference to FIG. 3 for a schematic view of a naked eye 3D polarized structure of the present invention, the naked eye 3D polarized structure comprises a polarizer, and a 3D grating layer 30 disposed in the polarizer, wherein the polarizer includes a polarizing element 20 and a surface treatment layer 40. The 3D grating layer 30 is disposed between the polarizing element 20 and the surface treatment layer 40. The polarizing element 20 includes an adhesive layer 201, an optical quarter wave plate layer 202 (λ/4), a TAC layer 203 (cellulose triacetate), a PVA layer 204 (polyvinyl alcohol), and a TAC layer 205 sequentially disposed on one another. The 3D grating layer 30 is disposed on the TAC layer 205.

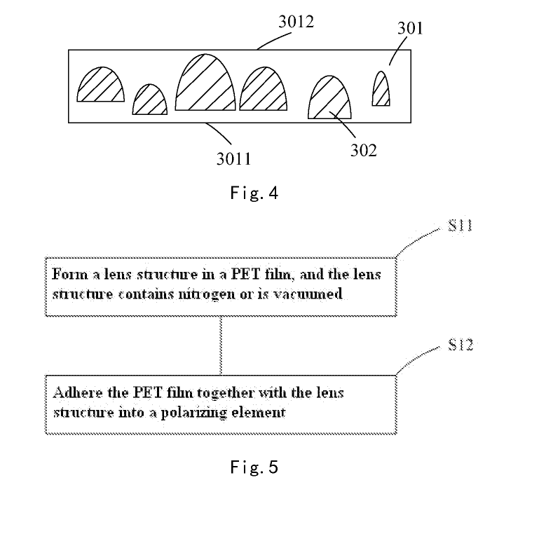

With reference to FIG. 4 for a cross-sectional view of the 3D grating layer 30 as depicted in FIG. 3, the 3D grating layer 30 includes a PET film 301 and a lens structure 302, and the lens structure 302 is formed inside the PET film 301, and the lens structure 302 contains nitrogen therein or is vacuumed, such that there is a refractive index difference value between the interior of the lens structure 302 and the PET film 301 outside the lens structure 302, and images are projected in different directions through the lens structure 302 to achieve the naked eye 3D effect. A lower surface 3011 of the PET film 301 is attached onto the TAC layer 205 of the polarizing element 20, and the lower surface 3011 of the PET film 301 is a focal plane of the lens structure 302 and an image plane to realize an image. An upper surface 3012 of the PET film 301 has a surface treatment layer 40 which is an optical film (HC/AR/LR/AG) with the functions of anti-reflection, anti-glare, and surface hardness treatment.

The lens structures 302 in the 3D grating layer 30 and the pixel structures are corresponsive to one another. In other words, each pixel structure corresponds to a lens structure 302, and the size and shape of the lens structure 302 vary with the pixel structure. Specifically, if the pixel structure is a centrosymmetrical regular figure, and the shape of the lens structure 302 corresponsive to the pixel structure is in the shape of a spherical lens, the lens structure 302 is greater than the pixel structure. The centrosymmetrical regular figure includes a circle, a square, an isosceles triangle, an equilateral pentagon, a hexagon, etc, and also includes a regular polygon with inverted angle processing. If the pixel structure is a non-centrosymmetrical figure, and the shape of the lens structure 302 corresponsive to the pixel structure is in the shape of an ellipsoidal lens, the lens structure 302 is greater than the pixel structure. The non-centrosymmetrical figure includes a rectangle or a rhombus, and also includes a scalene quadrilateral or polygon.

In the method of using each pixel structure corresponsive to a lens structure, the optical path between the lens structures will not be interfered, so that the Moire phenomenon can be reduced or even eliminated.

The naked eye 3D polarized structure of the present invention has the following advantages and effects:

The lens structure 302 is formed inside the PET film 301, so that the PET film 301 is capable of protecting the lens structure 302, and preventing the mechanical property of the display equipment from being affected by external stresses in the process of attaching or using the 3D grating plate 30, so as to effectively overcome the issue of damaging the 3D grating plate or the TP structure by external stresses easily.

The 3D grating plate 30 is installed between the polarizing element 20 and the surface treatment layer 40 to form a 3D polarized structure, so as to achieve the effects of simplifying the manufacturing procedure of the naked eye 3D display equipment, skipping the process of attaching the 3D grating plate, and improving the production efficiency. Such arrangement also reduces the error of attaching the naked eye 3D display equipment to improve the product quality.

With the technical solution of using a lens structure corresponsive to a single pixel structure, the optical path between the lens structures will not be inferred or overlapped with one another, so that the Moire phenomenon of the naked eye 3D image can be reduced or even eliminated. The size and shape of the lens structure vary with the pixel structure, so that human eyes just see the black screen at a specific position when the black gap between the graphic elements is amplified by the lens structure.

With reference to FIG. 5 for a flow chart of a manufacturing method of a naked eye 3D polarized structure in accordance with the present invention, the manufacturing method comprises the following steps:

S11: Form a lens structure 302 inside a PET film 301. The lens structure 302 contains nitrogen therein or is vacuumed. In a preferred embodiment of the present invention, the PET film 301 with the lens structure 302 is formed by a 3D printing technology, wherein the specific shape and size of the lens structure 302 are designed in advance according to an image. In the present invention, the lens structures 302 are corresponsive to the pixel structures in the image. The size of the pixel structure determines the size and shape of the lens structure 302. The lens structure 302 is greater than the pixel structure, and a single lens structure 302 covers a single pixel structure. The lens structure 302 is generally in the shape of a spherical lens or an ellipsoidal lens. A 3D printer is provided for printing and forming a PET film and a lens structure 302 inside the PET film. In another preferred embodiment of the present invention, the specific shape and size of the lens structure 302 are designed according to the image by a PET embossing method, and the convex-surface template with the lens structure 302 is produced. The PET film 301 and the convex-surface template are used to form the PET film with the lens structure, and a layer of PET film is laminated at the bottom of the PET film in order to wrap the lens structure into the PET film.

The interior of the lens structure 302 inside the PET film 301 contains nitrogen or is vacuumed by the following method. In a nitrogen environment or a vacuum environment, the lens structure 302 is formed, so that lens structure 302 is filled with the nitrogen or vacuumed, and there is a refractive index difference between the interior and exterior of the lens structure 302, and an image is projected in different directions through the lens structure 302 to achieve the naked eye 3D effect. In the method of filling nitrogen into the lens structure 302 or vacuuming the lens structure 302, the lens structure 302 contains nitrogen or is vacuumed, so that there is a refractive index difference between the interior and exterior of the lens structure 302 to achieve the naked eye 3D effect.

S12: Install the PET film 301 containing the lens structure 302 into the polarizer. The manufacturing method of the polarizer is the same as the conventional manufacturing method and comprises a polarizing element 20 and a surface treatment layer 40, wherein the polarizing element 20 includes an adhesive layer 201, an optical quarter wave plate layer 202 (Lambda/4), a TAC layer 203 (cellulose triacetate), a PVA layer 204 (polyvinyl alcohol), and a TAC layer 205 arranged sequentially. The PET film 301 containing the lens structure 302 is installed on the TAC layer 205 in the polarizing element 20, and the surface treatment layer 40 is disposed on the PET film 301, and the surface treatment layer 40 is an optical film (HC/AR/LR/AG) having the functions of anti-reflection, anti-glare and surface hardness treatment. In a preferred embodiment of the present invention, the PET film 301 is disposed in the polarizer by an adhesion method, wherein the PET film 301 is adhered between the polarizing element 20 and the surface treatment layer 40 to form the naked eye 3D polarized structure, and the polarized structure is used to manufacturing a display screen to obtain a naked eye 3D display screen.

The manufacturing method of a naked eye 3D polarized structure in accordance with the present invention has the following advantages and effects:

The lens structure 302 is formed inside the PET film 301, so that the PET film 301 provides a protection to the lens structure 302 to prevent external stresses from affecting the mechanical property of the display equipment during the process of attaching or using the 3D grating plate 30 to effectively overcome the issue of the prior art that the 3D grating plate or the TP structure may be damaged by the external stress easily.

The 3D grating plate 30 is installed between the polarizing element 20 and the surface treatment layer 40 to form a 3D polarized structure, and such arrangement achieves the effects of simplifying the manufacturing procedure of the naked eye 3D display equipment, skipping the process of attaching the 3D grating plate, improving the production efficiency, reducing the error of attaching the naked eye 3D display equipment, and improving the product quality.

With the technical solution of having a lens structure corresponsive to a single pixel structure, the optical path between the lens structures will not be interfered or overlapped, so that the Moire phenomenon of the naked eye 3D image can be reduced or even eliminated. The size and shape of the lens structure vary with the pixel structure to avoid the phenomenon of human eyes seeing the black screen at a specific position only after the black gap between the graphic elements is amplified by the lens structure.

While we have shown and described the embodiment in accordance with the present invention, it should be clear to those skilled in the art that further embodiments may be made without departing from the scope of the present invention.

What is claimed is:

1. A polarized structure for naked-eye 3D displaying, comprising:
a polarizer, and
a 3D grating layer disposed in the polarizer, the 3D grating layer including a PET film and a lens structure disposed in the PET film, wherein the lens structure containing nitrogen therein or being vacuumed.

2. The polarized structure as claimed in claim 1, wherein the lens structure is corresponsive to a pixel structure.

3. The polarized structure as claimed in claim 2, wherein the lens structure is in shape of a spherical lens or an ellipsoidal lens.

4. The polarized structure as claimed in claim 2, wherein the lens structure is greater than the corresponding pixel structure.

5. The polarized structure as claimed in claim 3, wherein the lens structure is greater than the corresponding pixel structure.

6. The polarized structure as claimed in claim 1, wherein the polarizer includes a polarizing element and a surface treatment layer, and the 3D grating layer is disposed between the polarizing element and the surface treatment layer.

7. A manufacturing method of a polarized structure for naked-eye 3D displaying, comprising the steps of:
forming a lens structure inside a PET film, and
installing the PET film together with the lens structure into the polarizer.

8. The manufacturing method of the polarized structure as claimed in claim 7, comprising the steps of:
introducing nitrogen in the lens structure.

9. The manufacturing method of the polarized structure as claimed in claim 7, comprising the steps of:
forming a lens structure inside a PET film, and
installing the PET film together with the lens structure into the polarizer.

10. The manufacturing method of the polarized structure as claimed in claim 7, comprising the steps of:
the lens structure being vacuumed.

11. The manufacturing method of the polarized structure as claimed in claim 7, wherein the lens structure is corresponsive to a pixel structure.

12. The manufacturing method of the polarized structure as claimed in claim 7, wherein the step of forming the lens structure comprises the steps of:
forming a lens structure in a nitrogen environment.

13. The manufacturing method of the polarized structure as claimed in claim 7, wherein the step of forming the lens structure comprises the steps of:
forming a lens structure in a vacuum environment.

14. The manufacturing method of the polarized structure as claimed in claim 9, wherein the step of forming the lens structure comprises the steps of:
forming a lens structure in a nitrogen environment.

15. The manufacturing method of the polarized structure as claimed in claim 9, wherein the step of forming the lens structure comprises the steps of:
forming a lens structure in a vacuum environment.

16. The manufacturing method of the polarized structure as claimed in claim 11, wherein the step of forming the lens structure comprises the steps of:
forming a lens structure in a nitrogen environment.

17. The manufacturing method of the polarized structure as claimed in claim 11, wherein the step of forming the lens structure comprises the steps of:
forming a lens structure in a vacuum environment.

18. The manufacturing method of the polarized structure as claimed in claim 7, wherein the step of forming the lens structure comprises the steps of:
filling nitrogen into the lens structure.

19. The manufacturing method of the polarized structure as claimed in claim 7, wherein the step of forming the lens structure comprises the steps of:
the lens structure being vacuumed.

20. The manufacturing method of the polarized structure as claimed in claim 9, wherein the step of forming the lens structure comprises the steps of:
filling nitrogen into the lens structure.

21. The manufacturing method of the polarized structure as claimed in claim 9, wherein the step of forming the lens structure comprises the steps of:
the lens structure being vacuumed.

22. The manufacturing method of the polarized structure as claimed in claim 11, wherein the step of forming the lens structure comprises the steps of:
filling nitrogen into the lens structure.

23. The manufacturing method of the polarized structure as claimed in claim 11, wherein the step of forming the lens structure comprises the steps of:
the lens structure being vacuumed.

24. The manufacturing method of the polarized structure as claimed in claim 7, wherein the lens structure is formed inside the PET film by a 3D printing technology.

25. The manufacturing method of the polarized structure as claimed in claim 7, wherein the lens structure is formed inside the PET film by a PET embossing method.

26. The manufacturing method of the polarized structure as claimed in claim 9, wherein the lens structure is formed inside the PET film by a 3D printing technology.

27. The manufacturing method of the polarized structure as claimed in claim 9, wherein the lens structure is formed inside the PET film by a PET embossing method.

28. The manufacturing method of the polarized structure as claimed in claim 11, wherein the lens structure is formed inside the PET film by a 3D printing technology.

29. The manufacturing method of the polarized structure as claimed in claim 11, wherein the lens structure is formed inside the PET film by a PET embossing method.

30. The manufacturing method of the polarized structure as claimed in claim 11, wherein the lens structure is greater than the corresponding pixel structure.

31. The manufacturing method of the polarized structure as claimed in claim 7, wherein the polarizer includes a polarizing element and a surface treatment layer, and the 3D grating layer is disposed between the polarizing element and the surface treatment layer.
